(19) United States
(12) Patent Application Publication
(10) Pub. No.: US 2017/0058964 A1
(43) Pub. Date: Mar. 2, 2017

(54) DOG CLUTCH

(71) Applicant: Ralph SCHIMPF, Furth (DE)

(72) Inventor: Ralph SCHIMPF, Furth (DE)

(73) Assignee: Schaeffler Technologies AG & Co. KG, Herzogenaurach (DE)

(21) Appl. No.: 15/247,612

(22) Filed: Aug. 25, 2016

(30) Foreign Application Priority Data
Aug. 27, 2015 (DE) 102015216364.4

(51) Int. Cl. F16D 11/14

(52) U.S. Cl. CPC F16D 11/14; F16D 2250/0023; F16D 2011/008

(57) ABSTRACT

A dog clutch for the controllable positive connection of two drive components situated coaxially around an axis of rotation. Two ring parts form the connection, including an inner ring and an outer ring that are movable axially relative to each other under external control to selectively make and break the connection therebetween. To produce the dog clutch simply and economically, the ring parts include teeth to form radial gearing with each other. At least one of the two ring parts is produced without machining, while its toothed part that forms the radial gearing is produced by punching and stamping.

### BACKGROUND OF THE INVENTION

Field of the Invention

The present invention relates to a dog clutch for a controllable, positive connection of two drive components situated coaxially around an axis of rotation and having two ring parts that form the connection. The ring parts include an inner ring and an outer ring that are movable axially relative to each other under external control to make and to break a rotary connection between the ring parts.

Description of the Related Art

Dog clutches are used for controllably connecting drive components, for example connecting an idler gear and a gear shaft, two shafts, or the like, and are generally known, for example, from DE 10 2013 220 251 A1. Alternatively, such a connection can be provided non-positively by means of a friction clutch, such as a multi-plate clutch. The known connection options are expensive to produce and require much construction space.

An object of the present invention is to provide a dog clutch that is simple and economical to produce. In particular, the dog clutch should require little axial construction space.

### SUMMARY OF THE INVENTION

The dog clutch in accordance with the present invention provides for the controllable, positive connection of two drive components that are situated coaxially around an axis of rotation, in particular in an automatic transmission. Two ring parts are provided to form the connection, in particular an inner ring and an outer ring. The rings are arranged so that they can be moved axially relative to each other to make and break the connection. Their axial movement is controlled externally by means of an actuator, for example an electric actuator, or a hydraulic or pneumatic piston/cylinder unit. The actuator is controlled by means of a control device, for example a motor or engine controller. In that case, one ring part can be axially fixed and the other part axially movable relative thereto and operated by the actuator.

The ring parts form radial gearing with each other, with at least one of the two ring parts, preferably both ring parts, being produced without machining. In that case, a toothed part that forms the radial gearing is punched and stamped. That means that the ring part or parts are die-cut and formed without machining, wherein the ring parts formed in that way are punched from sheet metal, for example, and possibly reshaped to form an axial collar, during which the teeth distributed around the circumference and extended radially relative to the collar of the ring part are stamped to their final shape.

The present invention also includes a method for producing the proposed ring part or parts, with at least the process steps of punching out of sheet metal a ring part with radially extended teeth, possibly reshaping the ring part and stamping the teeth.

In a preferred manner, at least one insertion slope in the joining direction of the connection is stamped onto the teeth of the toothed part without machining. In that case, the ring part can be produced by die-cutting in a multi-step press.

Advantageously, in the push and/or pull direction of the dog clutch, the teeth include tooth flanks that are in contact with each other to transfer the present forces in the circumferential direction when the clutch is engaged, and without needing any axial force. A transfer can be provided here only in the push or pull direction, so that corresponding tooth flanks with mating surfaces in contact are formed only in one direction of force. In a preferred manner, forces are transferable in the push and pull directions. To that end, tooth flanks with mating surfaces are provided on the teeth in both torque transfer directions. The teeth can be designed symmetrically or asymmetrically with regard to the mating surfaces of the tooth flanks that form the engaged connection. The symmetry of the teeth depends in particular on the design of the insertion slopes.

For example, to form the insertion slopes the teeth can have insertion slopes that are offset relative to a plane that extends perpendicular to the axis of rotation. For example, on each single tooth a single insertion slope that is directed into a single tooth flank can be formed. That means that during the joining of the separable connection of the dog clutch, the teeth of a toothed part are moved axially in the direction of the teeth of the other toothed part, during which the insertion slopes of the teeth are always twisted in the same direction of rotation and subsequently mesh with each other axially.

Alternatively, two insertion slopes can be formed on a tooth, each directed at a tooth flank, for example in a roof shape. The direction of rotation of the joining process depends, in that case, on where, that is, on which of the two insertion slopes the teeth meet each other during the relative axial movement of the two ring parts.

The insertion slopes and the adjacent tooth flanks can have an involute transition. That means that the meeting teeth of the ring parts mesh with each other involutely as the dog clutch engages. Alternatively, because the teeth are stamped, a trapezoidal shape or any desired advantageous geometrically defined shape or a free shape can be formed on them.

According to a preferred embodiment, the inner ring can be axially fixed and the outer ring axially movable. To that end, for rotationally fixed and axially movable receiving, the outer ring can have external profiling, for example external teeth. Alternatively, the inner ring can be axially movable and the outer ring axially fixed. To that end, an appropriate internal profiling, for example internal teeth, can be provided on the inner circumference of the inner ring for rotationally locked rotary driving and axial movement. The internal teeth can be provided on an axially reshaped extension of the inner ring. Internal profiling or external profiling can be provided by rolling or broaching. In an advantageous manner, internal or external profiling can be produced in a multi-step procedure during the process of punching and stamping the ring parts.

According to a preferred embodiment, when the dog clutch is in the shifted state the tooth flanks can at least partially overlap on axial surfaces with transmission forces that operate exclusively in the circumferential direction. Through appropriate axial positioning of the axial surfaces of the tooth flanks, it is possible to provide sufficiently large contact surfaces as mating surfaces, despite differently sized surfaces of the tooth flanks due to the design of the insertion slopes of the teeth. For example, an optimized mating surface can be set at an axial stop of the dog clutch, or at a pre-adjusted or pre-adjustable position of the axially movable ring part. For example, the actuator can be calibrated to that position or it can be adapted continuously.

### BRIEF DESCRIPTION OF THE DRAWINGS

The present invention will be explained in further detail on the basis of the exemplary embodiment shown in FIGS. 1 through 6. The drawing figures show the following:

FIG. 1 is an end view of an inner ring of the dog clutch in accordance with the present invention,

FIG. 2 is a cross-sectional view of the inner ring of FIG. 1 taken along the cutting line A-A of FIG. 1,

FIG. 3 is an enlarged perspective view of the portion designated detail X of the inner ring shown in FIG. 1,

FIG. 4 is an end view of an outer ring of the dog clutch in accordance with the present invention,

FIG. 5 is a cross-sectional view of the outer ring of FIG. 4 taken along the cutting line B-B of FIG. 4,

FIG. 6 is an enlarged perspective view of the portion designated detail Y of the outer ring of FIG. 4.

### DESCRIPTION OF THE PREFERRED EMBODIMENTS

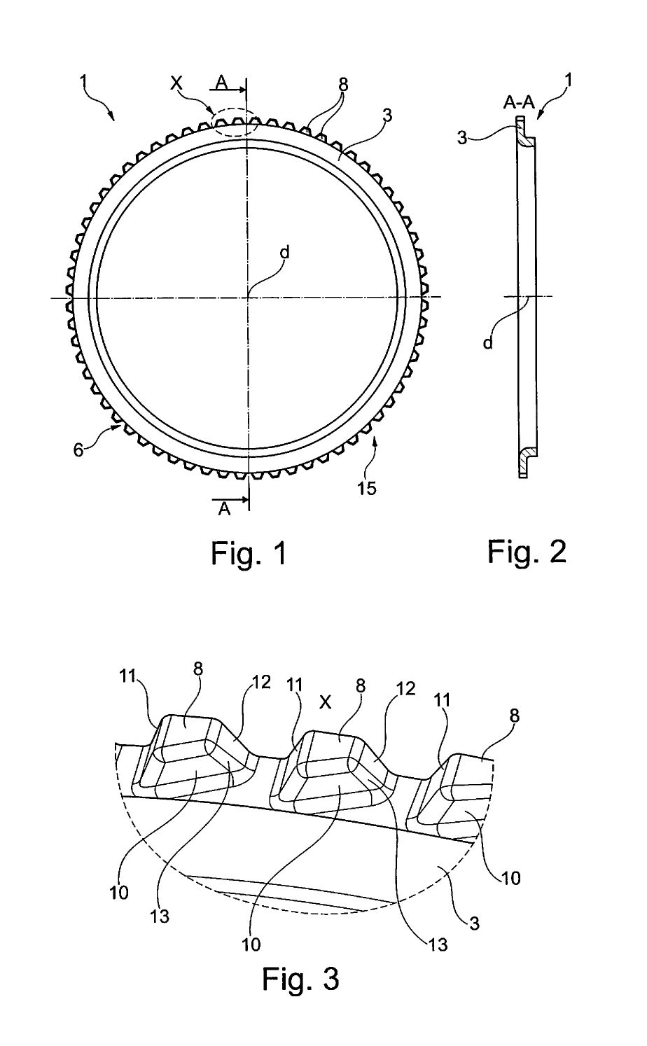

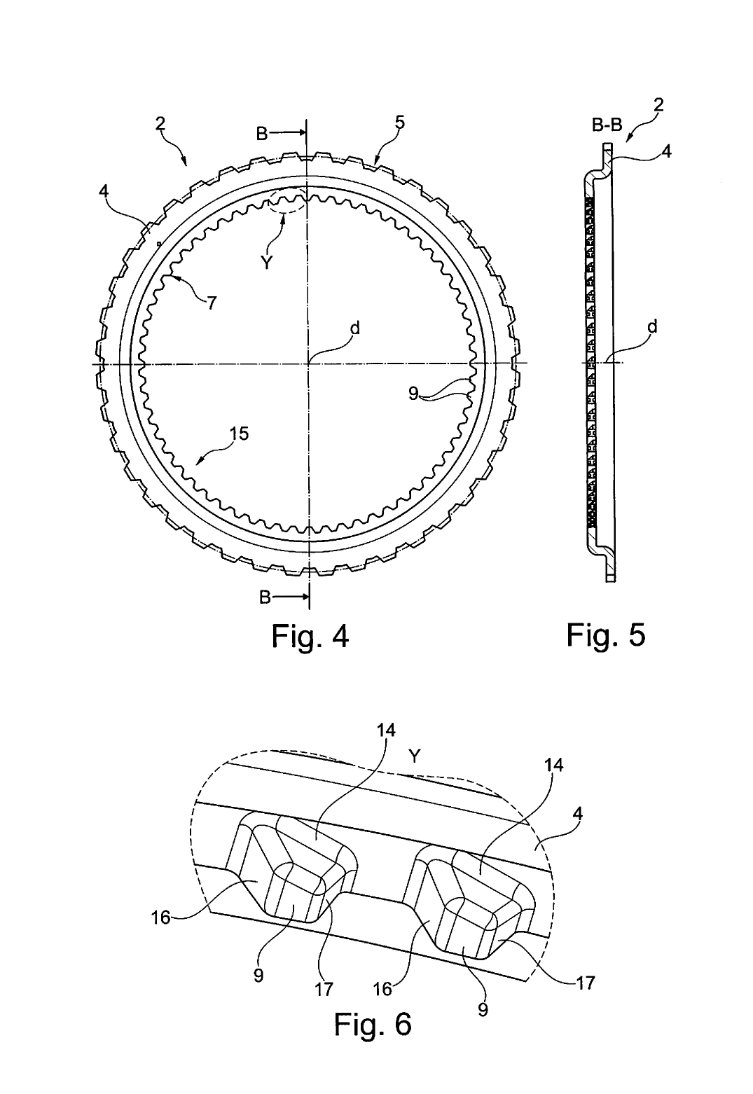

FIGS. 1 and 2 in combination show the ring part 1 designed as inner ring 3, and FIGS. 4 and 5 show the ring part 2 designed as outer ring 4. The rings are positioned concentrically around the axis of rotation d and thereby form the dog clutch in accordance with the present invention. The dog clutch is disengaged and engaged by moving the ring parts 1, 2 axially relative to each other. To that end, one of the two ring parts 1, 2, in that case for example, the inner ring 3, is held axially fixed and non-rotating with a rotatable drive component, for example a shaft, and the outer ring 4 is connected non-rotatingly and axially movably by means of the external teeth 5 to another drive component, for example held on an idler gear. The axially movable outer ring part 4 is moved axially by means of an actuator, for example by means of an electric motor and a gear unit, a hydraulic or pneumatic piston/cylinder unit or the like (not shown).

The ring parts 1, 2 are produced without machining, for example from sheet metal. Both ring parts 1, 2 have mutually complementary toothed parts 6, 7, that have radially extending teeth 8, 9. The teeth 8, 9 are produced by means of a stamping process, and they form the radial gearing 15 of the ring parts 1, 2 when the dog clutch is engaged.

FIG. 3 shows in an enlarged representation detail X of the ring part 1 of FIG. 1. The form of the stamped teeth 8 is clear from detail X. The teeth 8 have insertion slopes 10 that are situated at an acute angle relative to an imaginary plane perpendicular to the axis of rotation d of the ring part (FIG. 1), and that are positioned between the two tooth flanks 11, 12. The insertion slopes 10 give way at the transitions 13 of involute design to the tooth flanks 12, so that an optimized and low-friction transition with a positive lock with the teeth 9 of the ring part 2 (FIGS. 3 and 6) occurs.

FIG. 6 shows in an enlarged representation detail Y of the ring part 2 of FIG. 4 with a correspondingly complementary design of the teeth 9 to the teeth 8 of the ring part 1. The teeth 9 have correspondingly complementary insertion slopes 14 and tooth flanks 16, 17.

The combination of FIGS. 3 and 6 explains the operation of the proposed dog clutch. When the outer ring 4 is moved axially toward the inner ring 3, the insertion slopes 14 of outer ring 4 enter into contact with the insertion slopes 10 of the inner ring 3. Because of the resulting relative rotation of the outer ring 4 relative to the inner ring 3, the insertion slopes 10, 14 slide on each other in the circumferential direction until the tooth flanks 12, 16 contact each other. A positive lock is formed between the teeth 8, 9 by means of a further axial movement of the outer ring 4 relative to the inner ring 3. As that occurs, the tooth flanks 12, 16 form a positive lock in the pull direction of the clutch, and the tooth flanks 11, 17 form a positive lock in the push direction. Because of the different sizes of the tooth flanks 11, 16 on the one hand and the tooth flanks 12, 17 on the other hand, an optimized contact surface of the tooth flanks 11, 12, 16, 17 occurs by positioning the outer ring 4 appropriately relative to the inner ring 3.

What is claimed is:

1. A dog clutch for a controllable positive connection of two drive components situated coaxially around an axis of rotation, said clutch comprising:
two ring parts that form the controllable connection, including an inner ring and an outer ring that are movable axially relative to each other under external control to selectively make and break the connection, wherein the ring parts each include respective interengageable teeth to form a radial gearing connection with each other, and
wherein at least one of the two ring parts is produced without machining and includes a respective toothed part that forms the radial gearing connection and is produced by a punching and stamping process.

2. A dog clutch according to claim 1, wherein the teeth of the toothed ring parts include a stamped-on insertion slope facing a joining direction of the connection.

3. A dog clutch according to claim 2, wherein in each of an axially directed push and pull direction of the ring parts of the dog clutch the teeth have respective tooth flanks that face each other and contact each other when the ring parts are engaged.

4. A dog clutch according to claim 3, wherein the teeth of the ring parts have respective insertion slopes that are offset relative to a plane that is mounted perpendicular to the axis of rotation.

5. A dog clutch according to claim 4, wherein on each single tooth of each of the ring parts a single insertion slope is included that is directed into a single tooth flank.

6. A dog clutch according to claim 4 wherein a pair of insertion slopes are formed on each of the teeth of the ring parts and are directed at an opposed tooth flank of an opposed ring part during connection of the ring parts.

7. A dog clutch according to claim 4, wherein the insertion slopes and adjacent tooth flanks of the respective ring parts have an involute transition

8. A dog clutch according to claim 1, wherein the teeth of the respective ring parts are designed in a free shape.

9. A dog clutch according to claim 1, wherein the outer ring part includes external teeth on its outer circumference.

10. A dog clutch according to claim 3, wherein when the dog clutch is in a shifted state with the ring parts in driving contact with each other the tooth flanks of the respective ring parts at least partially overlap each other on axial surfaces to provide transmission forces that operate exclusively in the circumferential direction.
